(19) United States
(12) Patent Application Publication
(10) Pub. No.: US 2014/0359171 A1
(43) Pub. Date: Dec. 4, 2014

(54) DETECTION APPARATUS AND RELATED METHOD

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: PENG-FEI WANG, Shenzhen (CN); DONG-YAN LI, Shenzhen (CN); BING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/296,403

(22) Filed: Jun. 4, 2014

(30) Foreign Application Priority Data
Jun. 4, 2013 (CN) 2013102187817

(51) Int. Cl. G06F 11/22

(52) U.S. Cl. CPC G06F 11/2221
USPC 710/16

(57) ABSTRACT

A detection apparatus communicating with an peripheral device includes a determining module, a detecting module, a converting module, a comparing module, and a control module. The determining module controls the detecting module to transmit a corresponding testing program to the peripheral device while determining disc information is received from the peripheral device. The detecting module further controls the converting module to convert the feedback information into a parameter while detecting whether feedback information is received from the peripheral device. The comparing module compares the converted parameter and the standard parameter to generate a corresponding control signal for controlling the control module to generate different prompting information for indicating different detecting result of the peripheral device.

### CROSS-REFERENCE TO RELATED APPLICATIONS

This application claims priority to Chinese Patent Application No. 201310218781.7 filed on Jun. 4, 2013 in the China Intellectual Property Office, the contents of which are incorporated by reference herein.

### FIELD

The present disclosure relates to detection apparatus, particularly to a detection apparatus for a peripheral device.

### BACKGROUND

DVD players include a casing, a laser, and a photoelectric conversion chip pasted on the inside of the casing. The laser emits light on a disc received in the casing. The photoelectric conversion chip receives reflected light from the disc.

### BRIEF DESCRIPTION OF THE FIGURES

Implementations of the present disclosure will now be described, by way of example only, with reference to the attached figures, wherein:

FIG. 1 is a block diagram of an embodiment of a detection system.

FIG. 2 is a flowchart of an embodiment of a detecting method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts can be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

The present disclosure is described in relation to a detection apparatus for detecting whether a peripheral device 20 is qualified.

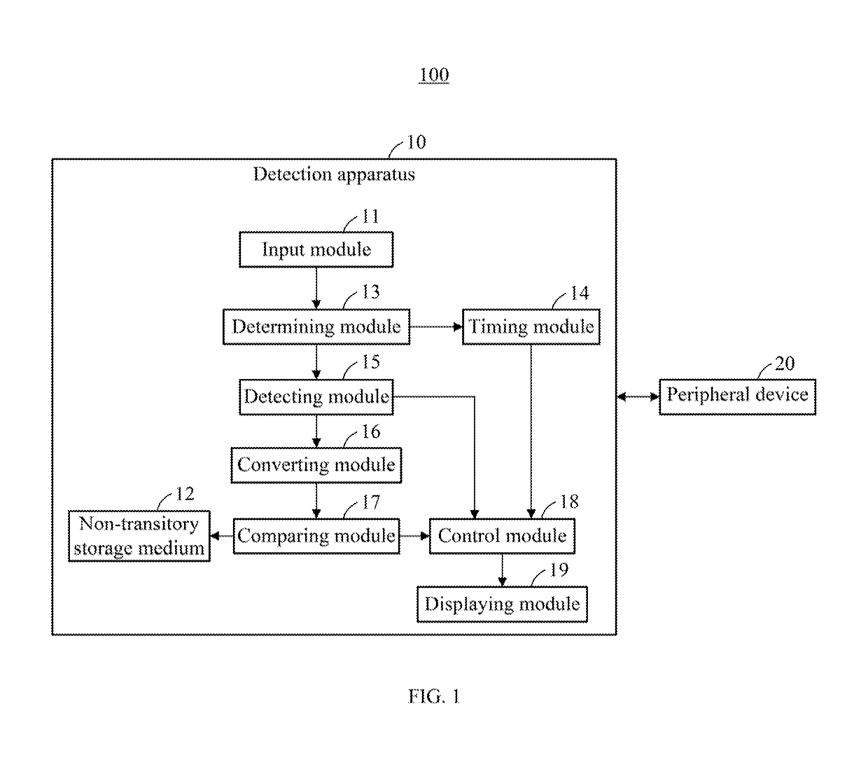

FIG. 1 illustrates an embodiment of a detecting system 100. The detecting system 100 includes a detection apparatus 10 and a peripheral device 20. The detecting apparatus 10 communicates with the peripheral device 20 and is used for detecting whether the peripheral device 20 is qualified. In one embodiment, the peripheral device 20 is a DVD player, and connects wirelessly with the detecting apparatus 10. In other embodiments, the peripheral device 20 is in a wired connection with the detecting apparatus 10.

The detecting apparatus 10 includes an input module 11, a non-transitory storage medium 12, a determining module 13, and a timing module 14, a detecting module 15, a converting module 16, a comparing module 17, and a control module 18, and a displaying module 19.

The input module 11 generates a corresponding command according to operations of the users. In one embodiment, the input module 11 can be a keyboard, a mouse, or a touch panel.

The non-transitory storage medium 12 stores a plurality of disc information in different formats, a plurality of testing programs corresponding to the disc information in one-to-one relationship, and a plurality of standard parameters corresponding to the disc information in one-to-one relationship. The testing programs are used for obtaining a feedback information of the peripheral device 20. In one embodiment, the non-transitory storage medium 12 can be a memory system of the device 1, and can be an external storage card, such as a smart media (SM) card, or secure digital (SD) card, for example. The standard parameters is a predetermined range or a predetermined value.

The determining module 13 determines whether disc information is received from the peripheral device 20 when the disc is contained in the peripheral device 20 or according to the command generated by the input module 11. When there is disc information, the determining module 13 further determines whether testing mode information is received from the peripheral device 20. When the testing mode information is not received from the peripheral device 20, the determining module 13 generates a timing signal.

The timing module 14 presets a predetermined time and times a detecting duration in response to the timing signal. The timing module 14 further generates a control signal when the detecting duration exceeds a predetermined time.

The control module 18 generates first prompting information in response to the first control signal. The first prompting information indicates that the detecting operation is greater than the predetermined time.

When the testing mode information is received from the peripheral device 20, the determining module 13 generates a detecting signal. The detecting module 15 transmits a testing program corresponding to the received disc information to the peripheral device 20 in response to the detecting signal, and determines whether feedback information from the peripheral device 20 is received by executing the transmitted testing program in the peripheral device 20. The feedback information is initial location information of the peripheral device 20 where reflected light from the disc is received. In one embodiment, the peripheral device 20 with a light sensor defines four quadrants, executes the received testing program to emit light on the disc, receives reflected light from the disc via a photoelectric conversion chip, and obtains the voltage change in the four quadrants, which is considered feedback information.

The detecting module 15 further determines whether feedback information from the peripheral device 20 is received in a predetermined time period. When no feedback information is received in the predetermined time period, the detecting module 15 further accumulates the number of failed times and determines whether the failed times exceeds a predetermined number. When the failed time does not exceed the predetermined number, the detecting module 15 continues to transmit the testing program corresponding to the received disc information. When the failed times exceeds the predetermined number, the detecting module 15 generates a second control signal.

The control module 18 further generates second prompting information in response to the second control signal. The second prompting information indicates that there is no feedback information received from the peripheral device 20.

When feedback information is received in the predetermined time period, the detecting module 15 generates a converting signal. The converting module 16 converts the feedback information into a parameter in response to the converting signal and generates a comparing signal.

The comparing module 17 compares the converted parameter with the standard parameter corresponding to the disc information in response to the comparing signal. When the converted parameter does not match the corresponding standard parameter, the comparing module 17 generates a third control signal. When the converted parameter matches the corresponding standard parameter, the comparing module 17 generates a fourth control signal.

The control module 18 further generates third prompting information in response to the third control signal, and generates fourth prompting information in response to the fourth control signal. The third prompting information indicates that the peripheral device 20 is unqualified. The fourth prompting information indicates that the peripheral device 20 is qualified and a disc changing operation is needed. The control module 18 further stores the converted parameter in the non-transitory storage medium 12.

The displaying module 19 displays the prompting information generated by the control module 18. In one embodiment, the prompting information can be, for example, video information, audio information, or text information for example.

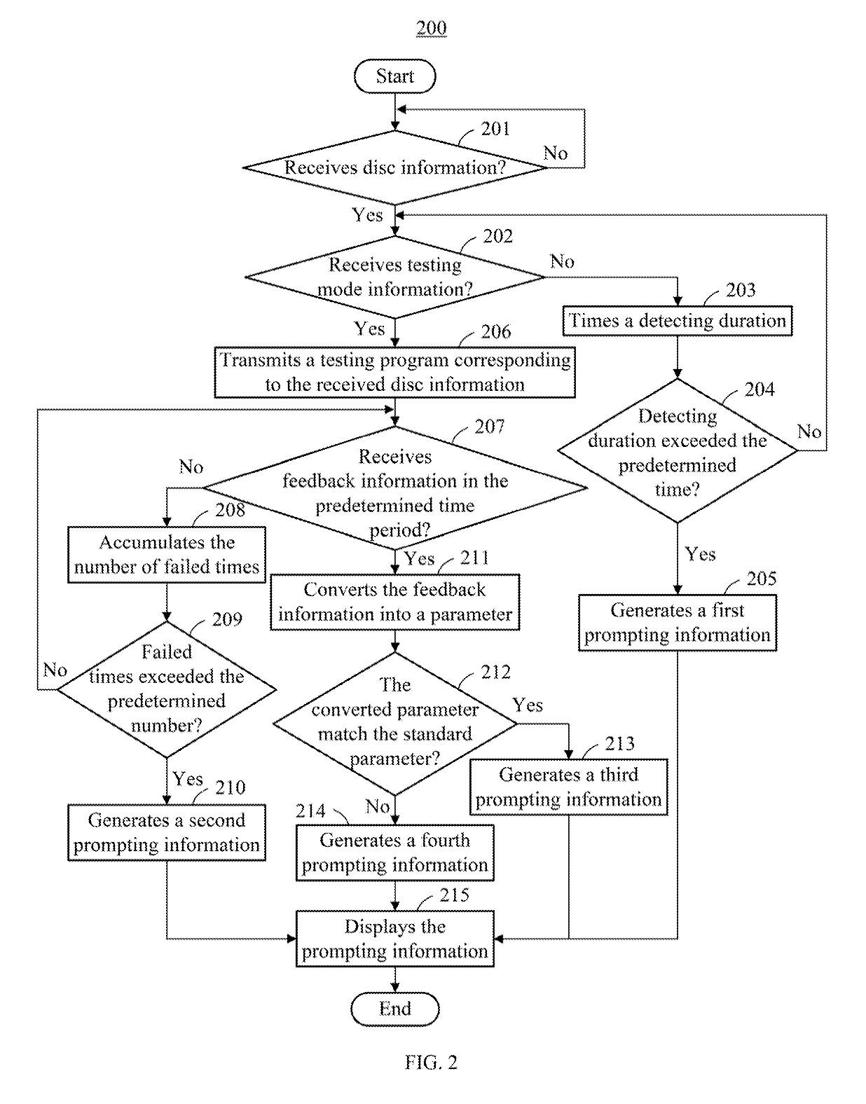

FIG. 2 illustrates that a flowchart is presented in accordance with an example embodiment. The method 200 is provided by way of example, as there are a variety of ways to carry out the method. The method 200 described below can be carried out using the configurations illustrated in FIG. 1, for example, and various elements of these figures are referenced in explaining the method 200. Each block shown in FIG. 2 represents one or more processes, methods or subroutines, carried out in the method 200. Furthermore, the order of blocks is illustrative only and the order of the blocks can change according to the present disclosure. Additional blocks can be added or blocks can be removed, without departing from this disclosure. The method 200 can begin at block 201.

At block 201, the determining module determines whether disc information is received from the peripheral device when the disc is contained in the peripheral device or according to the command generated by the input module. If the disc information is received, the procedure goes to 202. If there is no disc information received, the procedure returns to 201.

At block 202, the determining module further determines whether a testing mode information is received from the peripheral device. If a testing mode information is received from the peripheral device, a detecting signal is generated and the procedure goes to block 206. If the testing mode information is not received from the peripheral device, a timing signal is generated and the procedure goes to block 203.

At block 203, in response to the timing signal, the timing module times a detecting duration.

At block 204, the timing module further determines whether the detecting duration exceeds a predetermined time. If the detecting duration exceeds a predetermined time, a first control signal is generated and the procedure goes to block 205. If the detecting duration does not exceed a predetermined time, the procedure returns to block 202.

At block 205, in response to the first control signal, the control module generates first prompting information and procedure goes to block 215. The first prompting information indicates that the detecting operation is greater than the predetermined time.

At block 206, in response to the detecting signal, the detecting module transmits a testing program to the peripheral device corresponding to the received disc information.

At block 207, the detecting module further determines whether feedback information from the peripheral device is received in a predetermined time period by executing the transmitted testing program in the peripheral device. If there is no feedback information received in the predetermined time period, the procedure goes to block 208. If the feedback information is received in the predetermined time period, a converting signal is generated and the procedure goes to block 211.

At block 208, the detecting module further accumulates the number of failed times.

At block 209, the detecting module further determines whether the failed times exceeds a predetermined number. If the failed times exceeds the predetermined number, a second control signal is generated and the procedure goes to block 210. If the failed times does not exceed a predetermined number, the procedure returns to block 207.

At block 210, in response to the second control signal, the control module generates second prompting information and procedure goes to block 215. The second prompting information indicates that there is no feedback information received from the peripheral device.

At block 211, in response to the converting signal, the converting module converts the feedback information into a parameter, a comparing signal is generated and the procedure goes to block 212.

At block 212, in response to the comparing signal, the comparing module compares the converted parameter with the standard parameter corresponding to the disc information. If the converted parameter does not match the corresponding standard parameter, a third control signal is generated and the procedure goes to block 213. If the converted parameter matches the corresponding standard parameter, a fourth control signal is generated and the procedure goes to block 214.

At block 213, in response to the third control signal, the control module generates third prompting information and procedure goes to block 215. The third prompting information indicates that the peripheral device is unqualified.

At block 214, in response to the fourth control signal, the control module generates fourth prompting information in response to the fourth control signal and the method goes to block 215. The fourth prompting information indicates that the peripheral device is qualified and a disc changing operation is needed.

At block 215, the displaying module displays the prompting information generated by the control module.

In use, the detection apparatus 10 automatically detects an initial location of the peripheral device 20 and generates different prompting information for indicating different reasons. Thus, detecting operation convenience increases.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A detection apparatus communicated with a peripheral device, the detection apparatus comprising:
a non-transitory storage medium configured to store a plurality of disc information in different formats, a plurality of testing programs corresponding to the disc information in one-to-one relationship, and a plurality of standard parameters corresponding to the disc information in one-to-one relationship;
a determining module configured to determine whether a disc information is received from the peripheral device;
a detecting module configured to transmit a corresponding testing program to the peripheral device when the disc information is received from the peripheral device, and detecting whether a feedback information is received from the peripheral device generated by the executed testing program in the peripheral device;
a converting module configured to convert the feedback information into a parameter when the feedback information is received from the peripheral device;
a comparing module configured to compare the converted parameter and the standard parameter corresponding to the received disc information, and generating a corresponding control signal based on the comparing result; and
a control module configured to generate different prompting information for indicating different detecting result of the peripheral device based on the received control signal.

2. The detection apparatus of claim 1, wherein when the converted parameter matches the corresponding standard parameter, the comparing module generates a first control signal, and the control module generates first prompting information, the first prompting information indicates that the peripheral device is qualified.

3. The detection apparatus of claim 1, wherein when the converted parameter does not match the corresponding standard parameter, the comparing module generates a second control signal, and the control module generates second prompting information in response to the second control signal, the second prompting indicates that the peripheral device is unqualified.

4. The detection apparatus of claim 1, further comprising a timing module; wherein the timing module presets a predetermined time; when there is no disc information is received, the determining module generates a timing signal, and the timing module times a detecting duration in response to the timing signal and determines whether the detecting duration exceeds the predetermined time; when the detecting duration exceeds the predetermined time, the timing module generates a third control signal, and the control module generates third prompting information in response to the third control signal; the third prompting information indicates that the detecting operation is greater than the predetermined time.

5. The detection apparatus of claim 1, wherein when the disc information is received from the peripheral device, the determining module further determines whether a testing mode information is received from the peripheral device in a predetermined time period; when there is no testing mode information is received from the peripheral device in the predetermined time period, the detecting module further accumulates the number of failed times and determines whether the failed times exceeds the predetermined number; when the failed times exceeds the predetermined number, the determining module generates a fourth control signal, and the control module generates fourth prompting information in response to the fourth control signal; the fourth prompting information indicates that there is no feedback information received from the peripheral device.

6. The detection apparatus of claim 1, further comprising a displaying module, wherein the displaying module displays the prompting information generated by the control module.

7. The detection apparatus of claim 1, wherein the feedback information is a voltage change in four quadrants of a light sensor in the peripheral device caused by reflecting lights while executing the received testing program in the peripheral device.

8. A detecting method provided to a detection apparatus for detecting a qualified of an peripheral device, the detection apparatus storing a plurality of disc information in different types, a plurality of testing programs corresponding to the disc information in one-to-one relationship, and a plurality of standard parameters corresponding to the disc information in one-to-one relationship; the detecting method comprising:
determining whether a disc information is received from the peripheral device;
transmitting a corresponding testing program to the peripheral device when the disc information is received from the peripheral device;
detecting whether a feedback information is received from the peripheral device generated by the executed testing program in the peripheral device;
converting the feedback information into a parameter when the feedback information is received from the peripheral device;
comparing the converted parameter and the standard parameter corresponding to the received disc information to generate a corresponding control signal based on the comparing result; and
generating different prompting information for indicating different detecting result of the peripheral device based on the received control signal.

9. The method of claim 8, further comprising:
generating a first control signal when the converted parameter matches the corresponding standard parameter; and
generating first prompting information;
wherein the first prompting information indicates that the peripheral device is qualified.

10. The method of claim 8, further comprising:
generating a second control signal when the converted parameter does not match the corresponding standard parameter; and
generating second prompting information;
wherein the second prompting information indicates that the peripheral device is unqualified.

11. The method of claim 8, further comprising:
generating a timing signal when there is no disc information is received;
timing a detecting duration in response to the timing signal;
determining whether the detecting duration exceeds a predetermined time;
generating a third control signal when the detecting duration exceeds the predetermined time; and
generating third prompting information in response to the third control signal;
wherein the third prompting information indicates that the detecting operation is greater than the predetermined time.

12. The method of claim 8, further comprising:
determining whether a testing mode information is received from the peripheral device in a predetermined time period when the disc information is received from the peripheral device;
accumulating the number of failed times when there is no testing mode information is received from the peripheral device in the predetermined time period;
determining whether the failed times exceeds the predetermined number;
generating a fourth control signal when the failed times exceeds the predetermined number, the determining module; and
generating fourth prompting information in response to the fourth control signal;
wherein the fourth prompting information indicates that the feedback information receiving operation is failed.

13. The method of claim 8, further comprising: displaying the prompting information.

14. The method of claim 8, wherein the feedback information is a voltage change in four quadrants of a light sensor in the peripheral device caused by reflecting lights while executing the received testing program in the peripheral device.

15. A detection apparatus configured to communicate with a peripheral device, the detection apparatus comprising:
a non-transitory storage medium configured to store:
a plurality of disc information from a disc in one or more additional formats,
a plurality of testing programs each corresponding to one of the plurality of disc information.
a plurality of standard parameters each corresponding to one of the plurality of disc information,
a determining module configured to determine whether one or more of the plurality of disc information is received from the peripheral device;
a detecting module configured to:
transmit a corresponding testing program to the peripheral device upon receipt of disc information from the peripheral device by the testing program on the peripheral device;
a converting module configured to convert the feedback information into a parameter;
a comparing module configured to:
compare the converted parameter and the standard parameter;
and generate a corresponding control signal based on the comparing result,
a control module configured to generate different prompting disc information to indicate corresponding different detected results of the peripheral device based on the received control signal.

16. The detection apparatus of claim 15, wherein when the converted parameter matches the corresponding standard parameter, the comparing module generates a first control signal, and the control module generates first prompting information;
when the converted parameter does not match the corresponding standard parameter, the comparing module generates a second control signal, and the control module generates second prompting information in response to the second control signal, the second prompting indicates that the peripheral device is unqualified.

17. The detection apparatus of claim 15, further comprising a timing module;
wherein the timing module presets a predetermined time; when there is no disc information is received, the determining module generates a timing signal, and the timing module times a detecting duration in response to the timing signal and determines whether the detecting duration exceeds the predetermined time; when the detecting duration exceeds the predetermined time, the timing module generates a third control signal, and the control module generates third prompting information in response to the third control signal; the third prompting information indicates that the detecting operation is greater than the predetermined time.

18. The detection apparatus of claim 15, wherein when the disc information is received from the peripheral device, the determining module further determines whether a testing mode information is received from the peripheral device in a predetermined time period; when there is no testing mode information is received from the peripheral device in the predetermined time period, the detecting module further accumulates the number of failed times and determines whether the failed times exceeds the predetermined number; when the failed times exceeds the predetermined number, the determining module generates a fourth control signal, and the control module generates fourth prompting information in response to the fourth control signal; the fourth prompting information indicates that there is no feedback information received from the peripheral device.

19. The detection apparatus of claim 15, wherein the feedback information is a voltage change in four quadrants of a light sensor in the peripheral device caused by reflecting lights while executing the received testing program in the peripheral device.
